(19) United States
(12) Patent Application Publication
(10) Pub. No.: US 2025/0073661 A1
(43) Pub. Date: Mar. 6, 2025

(54) Food and Beverage Production System

(71) Applicant: James P. Janniello, Sarasota, FL (US)

(72) Inventor: James P. Janniello, Sarasota, FL (US)

(21) Appl. No.: 18/950,078

(22) Filed: Nov. 16, 2024

Related U.S. Application Data
(63) Continuation-in-part of application No. 18/330,344, filed on Jun. 6, 2023.

(51) Int. Cl. B01F 35/22; B01F 35/21; B01F 35/71; B01F 101/06

(52) U.S. Cl. CPC B01F 35/2206; B01F 35/2112; B01F 35/2115; B01F 35/2116; B01F 35/2205; B01F 35/2207; B01F 35/71805; B01F 2101/06

(57) ABSTRACT

An intelligent dispensing system includes a well and an electronically controlled valve having a valve input and a first valve output. A network interface is configured to obtain an encrypted recipe. The electronically controlled valve is configured to control a flow of an ingredient from the well to the first valve output based on the encrypted recipe.

### TECHNICAL FIELD

The present application relates generally to the mechanical, electrical, electronic, and computer arts, and more specifically, in one example, to a food and beverage production system.

### BACKGROUND

Beverages, including sodas, juices, coffees, lattes, milkshakes, wines, cocktails, and the like, are often mixed by hand, mixed by machine, or by a combination of hand and machine. Similarly, ingredients for food items are often mixed by hand, mixed by machine, or by a combination of hand and machine. The mixing of food ingredients and beverages may be performed in accordance with a custom list of ingredients, mixed using a particular technique (such as shaken or stirred), mixed and/or served at specific temperatures, and the like. On occasion, a barista or bartender may have a special recipe (including a list of ingredients, a special technique, a special set of steps, and the like) to mix a beverage that receives broad acclaim by connoisseurs of the particular type of beverage. In such cases, the owner of the recipe may wish to conceal and protect the recipe from disclosure (including public disclosure). Chefs and cooks may similarly have a special recipe (including a list of ingredients, a special technique, a special set of steps, baking temperatures, serving temperatures, and the like) for preparing food items, meals, desserts, and the like.

Machines for mixing beverages are generally available and used to perform mixing based on prescribed recipes. For example, the Mixo Two by Mixologiq of Paris, France accommodates twenty bottles of spirits, liqueurs, syrups, and fruit juices, and mixes cocktails according to recipes that are entered via a user interface and stored within the mixing machine. Similarly, machines for automatically producing food items, such as fresh bread, are generally available.

### BRIEF SUMMARY

Principles of the invention provide a food and beverage production system.

In one aspect, an intelligent dispenser comprises a network interface configured to obtain an encrypted recipe; a well configured to accept an ingredient; and an electronically controlled valve having a valve input and a first valve output, and configured to control a flow of the ingredient from the well to the first valve output based on the encrypted recipe.

In one aspect, a container tag comprises a network interface; a processor configured to indicate a status of a corresponding ingredient based on a decrypted recipe; a display driver; and a display configured to display the status of the corresponding ingredient.

The techniques disclosed herein provide numerous technical benefits. Each disclosed embodiment provides one or more of the following technical benefits:
a food and beverage production system that enables users to submit recipes in a secure environment where the confidentiality of the recipe is maintained and where the creator(s) of the recipe, the owner(s) of the recipe, the rights owner(s) of the recipe, or any combination of the foregoing is enabled to receive compensation in return for use of the recipe;
a food and beverage production system that enables the collection of royalties or other licensing fees by recipe creator(s), recipe owner(s), recipe rights owner(s) or any combination of the foregoing;
a blockchain technique that assists in protecting the security, rights, and privacy of recipes, assists in the transfer of ownership and/or rights of the recipe, maintains information related to computing royalty and licensing fees, and the like;
a food and beverage environment that enables submitted recipes to be distributed to beverage and food mixing machines in a secure manner, such that the contents of the recipe are protected from unauthorized inspection;
mechanisms that ensure that the details of a submitted recipe, such as one or more of the ingredients, the mixing technique, the production steps, the serving temperature, and the like, are not revealed to any unauthorized individual, any unauthorized system, or both;
enabling users, including users unauthorized to access details of a recipe, to customize a recipe without the details of the original recipe being revealed to the user;
enabling a user (such as the consumer of a food or beverage) to submit a personal profile that defines how beverages should be produced, including specifying recipes for beverages, modifications to existing recipes, preferences and the like;
an electronic container tag configured to provide one or more of: an identification of a container of an ingredient needed for a given recipe, an identification of when a given container of an ingredient should be accessed to add the ingredient to a beverage or food product that is currently in production and an identification of when a sufficient amount of an ingredient has been added to a beverage or food product that is currently in production;
an electronically controlled valve that controls an introduction of a selected ingredient into a beverage or food product based on an encrypted recipe;
an overflow mechanism that captures a residual amount of each ingredient where the electronically controlled valve allows the residual amount of the ingredient to flow from in an ingredient well into an overflow vessel;
a level indicator configured to indicate a height (volume) of an ingredient residing in an ingredient well and indicate whether a sufficient amount of the ingredient has been added to the ingredient well;
a level indicator configured to indicate a height (volume) of the ingredient(s) residing in a mixing vessel and indicate whether the total amount (volume) of ingredients added to the mixing vessel matches an expected amount, as prescribed by a given recipe (serves to confirm that the food or beverage product is being produced in accordance with the recipe and to confirm that the mixing vessel is properly engaged with an intelligent dispenser);
a locking mechanism configured to prevent the mixing vessel from being removed from the intelligent dispenser prior to the completion of the production of a food or beverage product (serves to prevent the mixing vessel from being removed prior to the completion of the production of the food or beverage product, which would risk unauthorized access to the protected recipe);
an engagement mechanism that ensures that the mixing vessel is properly attached to the intelligent dispenser while the beverage or food product is being produced and ensures that a user cannot detect the amount of each ingredient in a given recipe by operating the intelligent dispenser without the mixing vessel attached; and
a production cancellation mechanism that disguises the ingredients of a partially produced beverage or food product in the mixing vessel when the production is being cancelled (serves to ensure that a user cannot detect the amount of each ingredient in a partially produced beverage or food product when the production is cancelled).

### BRIEF DESCRIPTION OF THE DRAWINGS

Some embodiments are illustrated by way of example and not limitation in the figures of the accompanying drawings in which:

FIG. 1 is a block diagram of an example food and beverage production system, in accordance with an example embodiment;

FIG. 2 is a block diagram of an example apparatus for a food and beverage production system, in accordance with an example embodiment;

FIG. 3 is a flowchart for an example food and beverage production method, in accordance with an example embodiment;

FIG. 4A illustrates an example system for producing and dispensing beverages, in accordance with example embodiments;

FIG. 4B illustrates a first example intelligent dispenser for producing and dispensing beverages, in accordance with example embodiments;

FIG. 4C illustrates the first example intelligent dispenser of FIG. 4B with a bottle inserted in a well, in accordance with example embodiments;

FIG. 4D illustrates a second example intelligent dispenser for producing and dispensing beverages, in accordance with example embodiments;

FIG. 4E illustrates additional features of the intelligent dispensers of FIGS. 4A and 4B, in accordance with example embodiments;

FIG. 5 is a block diagram of an example bottle cap and example bottle collar, in accordance with example embodiments;

FIGS. 6A-6B illustrate a flowchart for a first example method for producing a beverage or food product, in accordance with example embodiments;

FIGS. 6C-6D illustrate a flowchart for a second example method for producing a beverage or food product, in accordance with example embodiments; and

FIG. 7 is a block diagram of a machine within which instructions may be executed for causing the machine to perform any one or more of the methodologies discussed herein.

### DETAILED DESCRIPTION

In the following detailed description of example embodiments, reference is made to specific examples by way of drawings and illustrations. These examples are described in sufficient detail to enable those skilled in the art to practice these example embodiments, and serve to illustrate how the invention may be applied to various purposes or embodiments. Other embodiments of the invention exist and are within the scope of the invention, and mechanical and other changes may be made without departing from the scope or extent of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

Generally, systems and methods for producing food, beverages or both are disclosed. Example embodiments enable users to submit recipes to a food and beverage production system where the confidentiality of the recipe is maintained and where the creator(s) of the recipe, the owner(s) of the recipe, the rights owner(s) of the recipe, or any combination of the foregoing receives compensation in return for use of the recipe. Food and beverage products created using the recipe may be marketed via the food and beverage production system or via other means to generate royalties or other licensing fees for recipe creators and/or owners.

In one example embodiment, a user, such as a barista, a bartender, a retail customer, and the like, can submit a recipe for mixing a beverage via a secure interface of the food and beverage production system. Similarly, a user, such as a chef, a retail customer, and the like, can submit a recipe for producing (such as mixing, baking, broiling, and the like) a food item via a secure interface of the food and beverage production system. In one example embodiment, the recipe is submitted to the food and beverage production system via a blockchain. The blockchain assists in protecting the security, rights, and privacy of the recipe, assists in the transfer of ownership and/or rights of the recipe, maintains information related to computing royalty and licensing fees, and the like. The food and beverage environment also enables the submitted recipe to be distributed to beverage mixing machines in a secure manner, such that the contents of the recipe are protected from unauthorized inspection. For example, the recipe may be encrypted prior to or in conjunction with incorporation into a blockchain.

In one example embodiment, the creator of the recipe, the submitter of the recipe, the owner of the rights to the recipe, an authorized user, or any combination of the above is compensated for submission of the recipe, permission to use the recipe, usage of the recipe or any combination of the foregoing. For example, the submitter of the recipe may receive compensation in exchange for ownership rights of the recipe, the submitter of the recipe may receive a royalty or licensing compensation for a right to use the recipe (such as a royalty for each serving of the beverage, a fee for unlimited use of the recipe during a specified time period, and a fee for unlimited use of the recipe on a given machine during a specified time period), and the like.

In one example embodiment, the submitted recipe is made available for selection via a user interface associated with, for example, a beverage mixing machine or other food and beverage production machine. In one example embodiment, details of the submitted recipe are protected and not accessible by unauthorized users, unauthorized systems, or both. For example, a purchaser of the beverage, a barista preparing the beverage via a beverage mixing machine, and the like may be denied access to the details of the recipe (such as an unencrypted version of the recipe). In one example embodiment, details of the submitted recipe, such as one or more of the ingredients, the mixing technique, the production steps, the serving temperature, and the like, are not revealed to any unauthorized individual, any unauthorized system, or both. For example, once submitted, the unencrypted recipe may only be accessible by the electronics of a given beverage mixing machine. The beverage mixing machine receives an encrypted version of the recipe via, for example, a blockchain and decrypts the recipe within a hardware device of the beverage mixing machine. In one example embodiment, the unencrypted recipe is only accessible by an authorized user(s), such as an authorized administrator; the recipe creator; the recipe submitter; a current recipe owner, rights owner, licensee, licensor, and the like; or any combination of the foregoing.

In one example embodiment, the food and beverage production system enables users, including a user unauthorized to access details of a recipe, to customize the recipe without the details of the recipe being revealed to the user. For example, the user may specify that the original recipe should be sweetened by adding a sweetener, may specify one or more ingredients to add to the recipe (regardless of whether the recipe is known by the user to contain or not contain the specified ingredient), may specify one or more ingredients to exclude from the recipe (regardless of whether the recipe is known by the user to contain or not contain the specified ingredient), may specify a particular serving temperature, and the like. For example, a person with an allergy to peanuts may customize the recipe to exclude peanuts. The customized recipe may then be stored for future use by the food and beverage production system in, for example, the beverage mixing machine, a food and beverage processing server, and the like. In one example embodiment, despite the recipe being customized by the user, the royalty and/or licensing terms of the original recipe will be applied to the customized recipe.

In one example embodiment, the creator, the submitter, the owner or any authorized user associated with the recipe may develop their own brand under which the recipe and/or corresponding beverage and/or food item is marketed and advertised. The marketing and advertising may be conducted via an interface of the food and beverage production system. A user of the beverage mixing machine, such as a bar owner, a bartender, a barista, a retail customer, and the like, may then select the advertised recipe/beverage/food item via a user interface associated with the mixing machine. In the situation where the recipe owner is due, for example, a per-serving royalty or other royalty/licensing fee, the mixing machine or an associated machine, such as a laptop computer, will credit the recipe owner with an indication of the royalty or licensing fee due (such as a royalty due for one or more servings). The credit may be applied when the servings are purchased, when the beverages are mixed, when the royalty/licensing agreement is executed and the like. In one example embodiment, the credit is applied by adding a block to a blockchain associated with the recipe. In one example embodiment, a blockchain is maintained for each recipe. In one example embodiment, a blockchain is maintained for each combination of recipe and mixing machine.

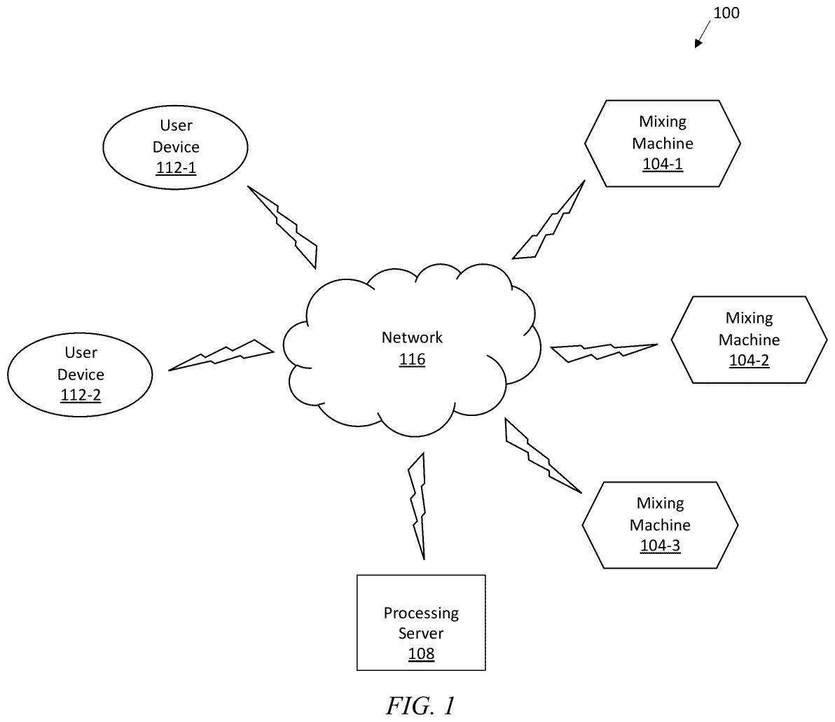

FIG. 1 is a block diagram of an example food and beverage mixing system 100, in accordance with an example embodiment. In one example embodiment, a plurality of mixing machines 104-1, 104-2, 104-3 (referred to collectively as mixing machines 104 herein) communicate via a network 116 with user devices 112-1, 112-2 (referred to collectively as user devices 112 herein) and a food and beverage processing server 108 (also referred to as processing server 108 herein). In one example embodiment, the mixing machine 104-1 includes a user interface that provides functionality similar to that of the user device 112. In one example embodiment, the food and beverage processing server 108 is a component of one or more of the mixing machines 104.

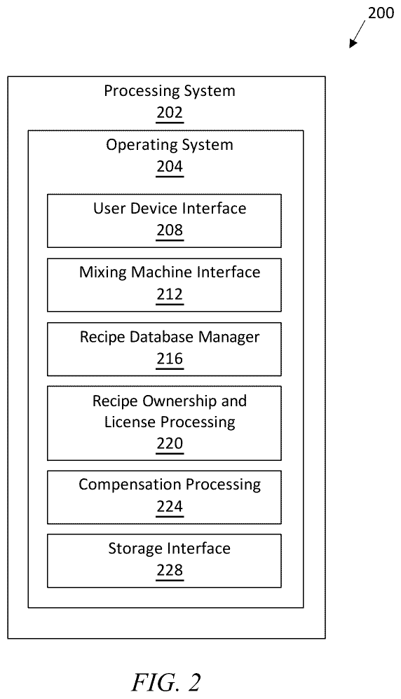

FIG. 2 is a block diagram of an example apparatus 200, in accordance with an example embodiment, for a food and beverage mixing system, in accordance with an example embodiment. The apparatus 200 is shown to include a processing system 202 that may be implemented on a client or other processing device that includes an operating system 204 for executing software instructions.

In accordance with an example embodiment, the apparatus 200 may include a user device interface 208, a mixing machine interface 212, a recipe database manager 216, a recipe ownership and license processing unit 220, and a compensation processing unit 224. In accordance with an example embodiment, the apparatus 200 may further include a storage interface 228.

The user device interface 206 enables a user to submit a recipe to the food and beverage production system 100, track the usage of and compensation for the recipe, customize a recipe, select a recipe for production, and the like. In one example embodiment, the submitted recipe is transferred directly to the food and beverage production system 100 or is transferred to the food and beverage production system 100 via the processing server 108. The submitted recipe is maintained by the recipe database manager 212. In one example embodiment, the recipe is encrypted and maintained in a blockchain associated with the recipe and the user device interface 206 enables a user to encrypt and incorporate the encrypted recipe into the blockchain. If a user is authorized to access data of the blockchain, such as a previously submitted recipe, data that tracks the usage of the recipe, and the like, the user device interface 206 provides access to the information.

In one example embodiment, the user device interface 206 enables a user to select a recipe for mixing at a particular mixing machine 104. The user device interface 206 enables a user to select a stored recipe for mixing at a particular mixing machine 104, customize a stored recipe, select a customized recipe for mixing, and the like.

In one example embodiment, the mixing machine interface 210 receives the recipe blockchain, decrypts the recipe, and provides details of the decrypted recipe to the mixing machine 104. The mixing machine interface 210 also provides feedback from the mixing machine 104 to the food and beverage production system 100 regarding the mixing of beverages that conform to the recipe. For example, the mixing machine 104 may provide feedback regarding the time of purchase or mixing of a beverage using the recipe, the number of servings mixed, the price charged (for determining royalties based on revenue), and the like. In one example embodiment, the mixing machine interface 210 enables a user to select the recipe to be used for mixing a beverage at a particular mixing machine 104. The recipe may be selected, for example, via the client device interface 206, via an interface of the mixing machine 104, via an interface of the processing server 108, via an application running on a smartphone or other client device (received via the network 116), and the like. In one example embodiment, the mixing machine interface 210 is a component of the mixing machine 104. In one example embodiment, the mixing machine interface 210 is a component of the processing server 108.

The recipe database manager 212 manages the submitted recipes. In one example embodiment, the submitted recipes are stored in blocks of blockchains and the recipe database manager 212 provides access to the recipes in the blockchains or provides access to the blockchains for, for example, the mixing machine 104 and/or the user devices 112-1, 112-2. The recipes may be stored in the blockchain via the client device interface 206, via an interface of the mixing machine 104, via an interface of the processing server 108, and the like. In one example embodiment, the recipes are encrypted prior to storage in the blockchain, prior to storage in the recipe database manager 212, or both.

Recipe ownership and license processing unit 214 processes changes in recipe ownership and logs licensing agreements. In one example embodiment, details and terms of the ownership and licensing agreements are maintained in the blockchain corresponding to the recipe.

The compensation processing unit 218 computes the compensation due to the owner and/or rights owner of the recipe. In one example embodiment, the rights to a recipe may be transferred to a new owner in return for compensation. In one example embodiment, the rights to a recipe are licensed to a licensee in return for a per-serving or other type of compensation, such as a per-machine compensation.

It is contemplated that the techniques for mixing beverages using the mixing machine 104 may be applied to other types of machinery for producing different types of food items, such as frozen pizzas, ice cream, condiments, seasonings, and the like.

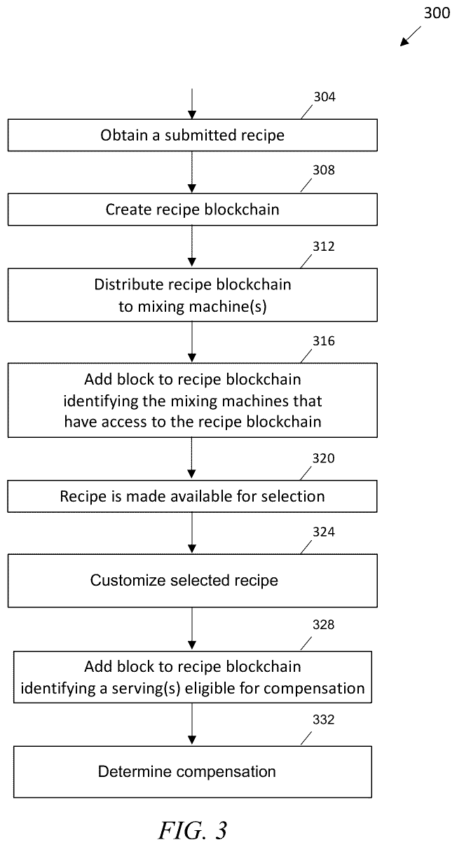

FIG. 3 is a flowchart for an example food and beverage production method 300, in accordance with an example embodiment. In one example embodiment, a user, such as a barista, a bartender, a retail a customer, and the like, submits a recipe for a food and/or beverage via an interface of the user device 112 to the processing server 108, directly to the mixing machine 104, or directly into a corresponding blockchain (operation 304). In one example embodiment, the recipe is encrypted before distribution, such as during operation 304. The user device 112, the processing server 108, or the mixing machine 104 creates a blockchain corresponding to the submitted recipe (operation 308) and the blockchain is distributed to the mixing machines 104, one of the user devices 112, the processing server 108, or any combination of the foregoing in a secure manner, such that the details of the recipe are not disclosed to unauthorized users, unauthorized systems or both (operation 312). A block is added to the blockchain identifying the mixing machines 104 that have received or otherwise have access to the corresponding recipe (operation 316). In one example embodiment, the recipe in the blockchain is encrypted and the mixing machine 104 or an associated device decrypts the recipe prior to use. In one example embodiment, the mixing machine 104 or other device authorized to decrypt the recipe is configured using tamperproof mechanisms, such as secure crypto processors, to decrypt and utilize the recipe, thus protecting the confidentiality of the recipe.

In one example embodiment, the submitted recipe is made available for selection via a user interface associated with a target mixing machine 104 (operation 320). For example, the submitted recipe may be made available via a user interface of the mixing machine 104-1, the user device 112-1, or the food and beverage processing server 108. In one example embodiment, only an identifier for the recipe is made available for selection, such as a name of the recipe, a brand name of the recipe, and the like. In one example embodiment, a selected recipe is customized by a user (operation 324). For example, a user may specify a sweetener is added to the selected recipe. The customized recipe may be stored for future use by the food and beverage production system 100, and may be made available for selection during, for example, a future execution of operation 320. The customized recipe may be presented as an option to the user who customized the recipe or another authorized user identified by the user who customized the recipe.

In one example embodiment, a block (such as a compensation block) is added to the recipe blockchain identifying serving(s) of the recipe that are eligible for compensation, such as purchased servings, delivered servings, mixed servings, and the like (operation 328). The compensation block may be added by the appropriate mixing machine 104, the processing server 108, the user device 112, and the like. The compensation block may be added when the beverage is purchased, when the beverage is mixed, when the beverage is delivered, and the like.

In one example embodiment, the compensation due to the recipe creator, the recipe owner, the recipe licensee, and the like is determined based on the blockchain that includes the compensation information, such as the number of servings produced (operation 332).

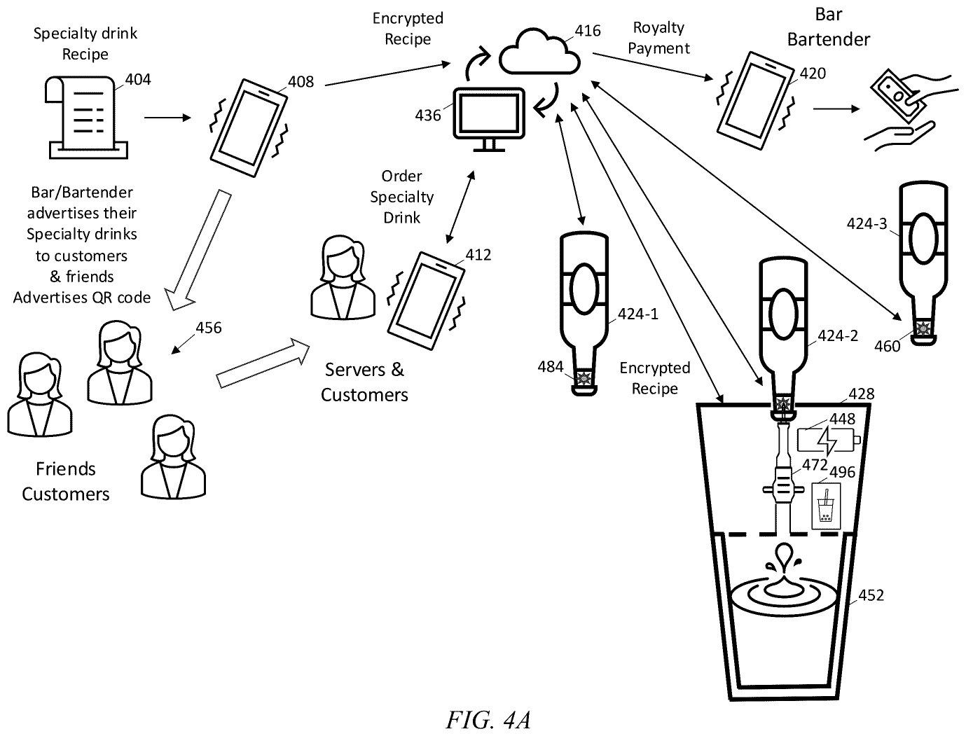

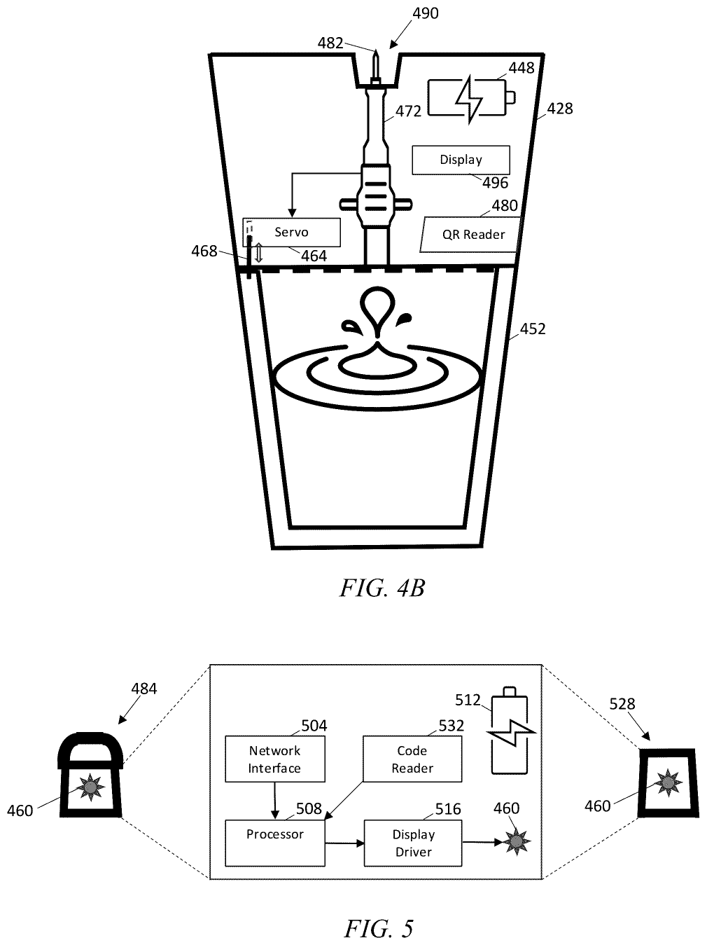

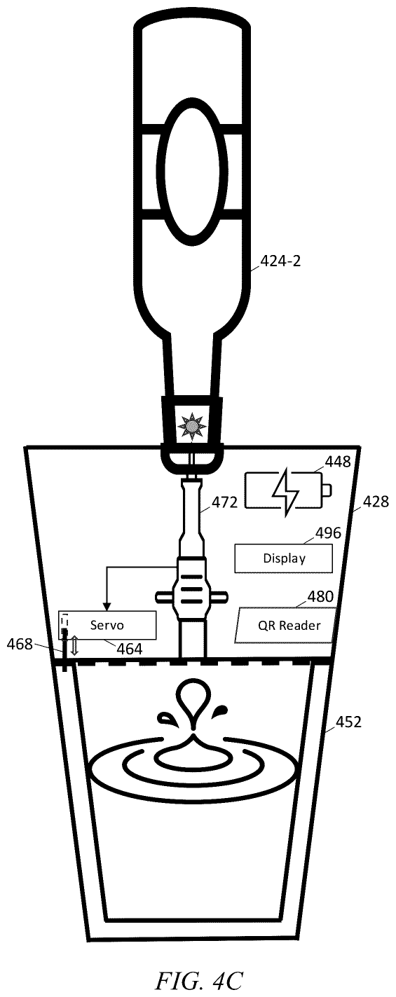

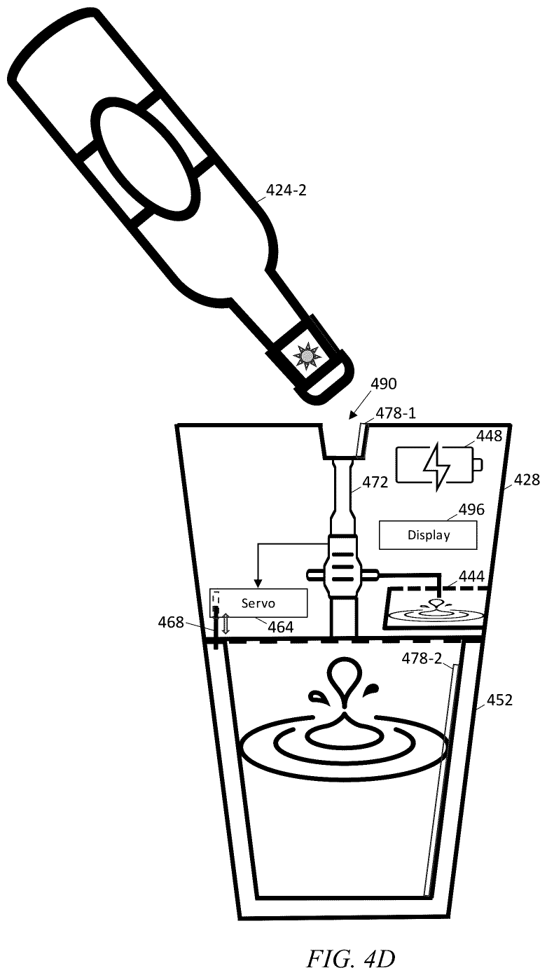

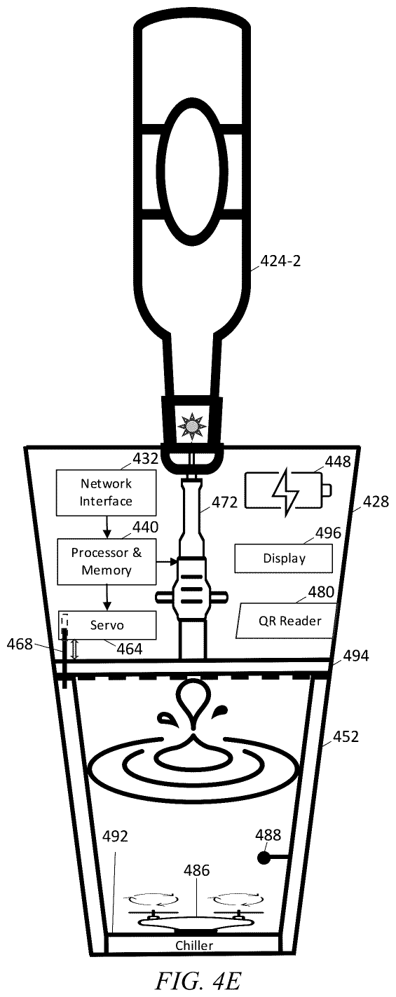

FIG. 4A illustrates an example system for producing and dispensing beverages, in accordance with example embodiments. FIG. 4B illustrates a first example intelligent dispenser 428 for producing and dispensing beverages, in accordance with example embodiments. FIG. 4C illustrates the first example intelligent dispenser 428 of FIG. 4B with a bottle 424-2 inserted in a well 490, in accordance with example embodiments. (It is noted that features described in the context of any disclosed embodiment are contemplated to be applicable to other described embodiments.) In example embodiments, the intelligent dispenser 428 is configured as a hand-held device and is powered by a battery 448. In example embodiments, the intelligent dispenser 428 is configured as a shaker, such as a cocktail shaker, a smoothie mixing, a hand-held blender and the like. A user, such as a recipe owner, restaurant owner, bartender, barista, beverage consumer and the like, submits a recipe 404 via an electronic device 408, such as a smartphone, a laptop computer, a point-of-sale terminal and the like. The recipe 404 describes a specialty beverage, a special version of an off-the-shelf beverage and the like. (The production of other items, such as other liquids, food products, powders, mixed spices, mixed dry cooking ingredients and the like is also contemplated.) As described herein, the recipe 404 is encrypted to protect the data from unauthorized access and is transported via a network 416 to, for example, a server 436 or another computing device. In example embodiments, the encrypted recipe is transferred directly to an intelligent dispenser 428.

In example embodiments, the submitter of the recipe 404 advertises their beverage, such as a specialty drink, to individuals 456, such as friends, customers and the like. The advertisement identifies the beverage and may include a quick response (QR) code or another identifier that identifies the beverage. A royalty, licensing compensation and the like may be provided to the creator of the recipe 404, the owner of the recipe 404, the rights-owner of the recipe 404 and the like, as described more fully above.

In example embodiments, a user submits a personal profile that defines how beverages should be produced. For example, a user can specify recipes for beverages, modifications to existing recipes, preferences and the like. The modifications may be based, for example, on allergy restrictions (such as allergies related to peanuts), diet restrictions (such as limits on alcohol, sugars and the like), beverage preferences (such as serving temperature, method of production, ingredients and brands of ingredients) and the like. Non-limiting examples of preferences include specifying sweeter beverages, limits on alcohol or sugars, method of production (stirred or shaken) and the like. When ordering a beverage, the user can specify whether all, or one or more elements of the profile are to apply to the production of a given beverage.

In example embodiments, a beverage order is submitted via an ordering device 412 by, for example, one of the individuals 456. The beverage may be identified by selecting or submitting a name of a drink, by scanning a QR code that identifies the recipe 404 and the like. In example embodiments, the server 436 retrieves the encrypted recipe for the ordered beverage and forwards the encrypted recipe to the production device, such as the intelligent dispenser 428. In example embodiments, the intelligent dispenser 428 may directly receive the encrypted recipe from the order device 412 or another device.

The intelligent dispenser 428 then decrypts the encrypted recipe and identifies the ingredients to be added to the vessel 452. (In example embodiments, the encrypted recipe is decrypted prior to transferal to the intelligent dispenser 428, such as decrypted by the server 436.) The ingredients may be identified by identifying each ingredient on a display screen (such as a display screen 496 of the intelligent dispenser 428, a display screen of the electronic device 408, a display screen of the ordering device 412 and the like), by turning on a light emitting device 460 (such as a light-emitting diode) of a bottle collar, bottle cap or other type of container tag of the ingredient (as described further below in conjunction with FIG. 5) and the like.

The identified ingredient is then added to the vessel 452 by inverting the ingredient container, such as the bottle 424-2, and inserting the bottle neck into the well 490 and the receptacle 482 of the intelligent dispenser 428. In example embodiments, a bottle cap 484 (as described further below in conjunction with FIG. 5) mounted on the bottle 424-2 mates with the receptacle 482 with a water-tight seal. (In example embodiments, the bottle neck, without the bottle cap 484, is inserted into the receptacle 482 with a water-tight seal.) In example embodiments, a probe or other device of the receptacle 482 serves to open a conduit through the bottle cap 484 after the water-tight seal has been engaged.

In example embodiments, an electronically controlled valve 472 is activated (switched to an open state) allowing the ingredient, such as a fluid, powders, grains, and the like, to flow from the container, such as the bottle 424-2, into the vessel 452. In example embodiments, the electronically controlled valve 472 includes a network interface (NIC), such as a Bluetooth interface, a Wi-Fi interface and the like, configured to receive the encrypted recipe and a processor configured to orchestrate the decryption of the recipe and control a production of the beverage according to the decrypted recipe. (In example embodiments, the intelligent dispenser 428 includes a network interface (NIC) 432, such as a Bluetooth interface, a Wi-Fi interface and the like, configured to receive the encrypted recipe and a processor 440 configured to orchestrate the decryption of the recipe 404 and control a production of the beverage according to the decrypted recipe 404.) Once the prescribed amount of the ingredient has flowed into the vessel 452 (as prescribed by the decrypted recipe 404), the electronically controlled valve 472 is deactivated (transitioning to the closed state), thereby preventing additional ingredients from flowing into the vessel 452. The above process is repeated for each ingredient of the decrypted recipe 404.

FIG. 4D illustrates a second example intelligent dispenser 428 for producing and dispensing beverages, in accordance with example embodiments. In example embodiments, the intelligent dispenser 428 includes a well 490 into which an ingredient is poured. Similar to the steps above, as each ingredient is identified and added to the vessel 452, the electronically controlled valve 472 allows the proper amount of the ingredient to flow into the vessel 452. While the intelligent dispenser 428 does not permit more of an ingredient to enter the vessel 452 than specified in the recipe 404, the intelligent dispenser 428 allows a residual amount to reside in the well 490 after the ingredient is added. In example embodiments, the electronically controlled valve 472 allows the remaining amount of the ingredient in the well 490 to flow into an overflow vessel 444. After a beverage is produced, the overflow vessel 444 may be removed from the intelligent dispenser 428, the excess ingredients in the overflow vessel 444 may be discarded and the overflow vessel 444 may be cleaned and reinstalled into the intelligent dispenser 428.

In example embodiments, a level indicator 478-1 is configured to indicate a height (volume) of an ingredient residing in the well 490. In example embodiments, the processor 440 or the processor of the electronically controlled valve 472 monitors the output of the level indicator 478-1 to determine when a sufficient amount of an ingredient has been added to the well 490, as prescribed by the recipe 404. Once the level indicator 478-1 indicates that a sufficient amount of an ingredient has been added to the well 490, the processor 440 provides a confirmation to the user. The confirmation may be provided via the display screen 496, via a display 460 of a bottle cap 484 or bottle collar 528 (as described more fully above in conjunction with FIG. 5) and the like. For example, an LED indicator of the bottle cap 484 or bottle collar 528 can be turned off once a sufficient amount of the corresponding ingredient has been added to the well 490. (It is noted that the incorporation of a weight scale into the well 490 is also contemplated to enable the prescription in the recipe 404 of an ingredient by weight, similar to the prescription in the recipe 404 of an ingredient by volume.)

In example embodiments, a level indicator 478-2 is configured to indicate a height (volume) of the ingredient(s) residing in the vessel 452. In example embodiments, the processor 440 or the processor of the electronically controlled valve 472 monitors the output of the level indicator 478-2 to determine whether the total amount (volume) of ingredients added to the vessel 452 matches the expected amount, as prescribed by the recipe 404, during each step of producing the beverage. This serves to confirm that the beverage is being properly produced and to confirm that the vessel 452 is properly engaged with the intelligent dispenser 428. (It is noted that the incorporation of a weight scale into the well 490 is also contemplated to enable the prescription in the recipe 404 of an ingredient by weight, similar to the prescription in the recipe 404 of an ingredient by volume.)

FIG. 4E illustrates additional features of the intelligent dispenser 428 of FIGS. 4A-4D, in accordance with example embodiments. It is noted that, if the vessel 452 is not attached as part of the intelligent dispenser 428 during the production of a beverage, a user could measure the amount of each ingredient as it flows from the intelligent dispenser 428, exposing the recipe 404 to an unauthorized user. In example embodiments, to protect the security of the recipe 404, a locking mechanism is activated to prevent the vessel 452 from being detached prior to the completion of the production of the beverage. For example, a pin 468 and a servo 464 may be used to lock the engagement of the intelligent dispenser 428 with the vessel 452 by lowering a pin 468 into the vessel 452 using the servo 464. The pin 468 serves to prevent the vessel 452 from, for example, being rotated and detached prior to the completion of the beverage.

In addition, in example embodiments, an engagement mechanism 494 ensures that the vessel 452 is properly attached while the beverage is being produced. This ensures that the production system works properly and ensures that a user cannot detect the amount of each ingredient by using the intelligent dispenser 428 without the vessel 452 attached. In example embodiments, the engagement mechanism 494 includes an identification tag, such as a non-volatile memory device that is embedded within the vessel 452 and that stores the identifier for the given vessel 452. The processor 440 or the processor of the electronically controlled valve 472 reads and validates the identification tag, and then enables the intelligent dispenser 428 to produce the beverage. In example embodiments, if the processor 440 or the processor of the electronically controlled valve 472 is not able to read and validate the identification tag, the processor 440 or the processor of the electronically controlled valve 472 disables the intelligent dispenser 428 from producing the beverage.

To cancel the production of a beverage that is in-progress, an amount of a cancellation ingredient that serves to disguise the amounts of the individual ingredients residing in the vessel 452 is added to the vessel 452. In example embodiments, a random amount of an ingredient, a random ingredient (such as water, sucrose and the like) or both is added to the vessel 452 using the above method. The random amount, the random ingredient or both are determined, for example, by the processor 440 or the processor of the electronically controlled valve 472. In example embodiments, the locking mechanism is not released until the cancellation ingredient has been added to the vessel 452.

Once the production process is complete, the vessel 452 is detached from the intelligent dispenser 428. For example, the locking mechanism 460, 464 may be unlocked and the vessel 452 may be rotated in to disengage the mating mechanism 494. The beverage may be served from the vessel 452 and the vessel 452 may be washed using conventional techniques.

In example embodiments, the intelligent dispenser 428, the vessel 452 or both includes an electric mixer 486. The electric mixer 486 includes blades or other mixing fixtures to mix and/or blend the ingredients in the vessel 452; crush, shred and/or shave ice in the vessel 452; and the like. In example embodiments, the recipe 404 specifies an amount of time, speed or both to operate the electric mixer 486 and the processor 440 controls the electric mixer 486 in accordance with the recipe 404. In example embodiments, the electric mixer 486 includes a paddle to stir the beverage for an amount of time, speed or both specified by the recipe 404.

In example embodiments, the vessel 452 can accommodate ice to chill the beverage to a specific temperature as it is being produced and/or after production. In example embodiments, the vessel 452 includes a chiller located, for example, at the bottom of the vessel 452. The chiller 492 may be implemented with a thermoelectric device. In example embodiments, a temperature sensor 488 enables the temperature of the contents of the vessel 452 to be monitored by the processor 440 or the processor of the electronically controlled valve 472. In example embodiments, the processor 440 or the processor of the electronically controlled valve 472 controls the chiller 492 based on the temperature indicated by the temperature sensor 488, in accordance with the recipe 404.

FIG. 5 is a block diagram of an example bottle cap 484 and example bottle collar 528, in accordance with example embodiments. While described in the context of a bottle cap and bottle collar, the device of FIG. 5 may be implemented as a cap, a collar, a tag and the like for other types of containers, such as boxes, cartons, kegs, barrels, pitchers and the like. (The bottle cap 484, bottle collar 528 and tag are collectively referred to as a container tag herein.) In example embodiments, each bottlecap 484 or bottle collar 528 has a network interface 504 (such as a Bluetooth interface, a WIFI interface and the like), a processor 508, a display driver 516, a battery 512 and a visible indicator 460 (such as a light-emitting diode). The processors described herein, including processor 440, processor 508 and the like may be implemented using a central processing unit, a digital signal processor, a finite state machine and the like.

In example embodiments, the processor 440 or the processor of the electronically controlled valve 472 is configured with a container tag map that correlates, for example, a name of each available ingredient with a network identifier of the container tag, enabling the processor 440 or the processor of the electronically controlled valve 472 to remotely control an indicator 460 on the container tag to indicate the status of the ingredient. In example embodiments, a bar code reader 532 of the container tag is provided to read a bar code on a container, where the bar code identifies the ingredient in the container. (Other types of readers 532 are contemplated, including QR code readers, text readers and the like.) The processor 508 then forwards an ingredient identifier (such as an ingredient name) and the network identifier of the corresponding container tag to the intelligent dispenser 428 such that the processor 440 or the processor of the electronically controlled valve 472 can generate the container tag map.

The visible indicator 460 may be implemented with one or more light-emitting diodes, an alpha-numeric display and the like. (Other types of indicators are contemplated, including audible indicators.) In example embodiments, the bottlecap 484 or bottle collar 528 receives an indication of whether it is the next ingredient to be added to the vessel 452, one of a plurality of ingredients to be added to the vessel 452 (but not the next ingredient) or an ingredient not used in the pending recipe 404. The indication may be sent to the bottlecap 484 or bottle collar 528 by the server 436, the intelligent dispenser 428 and the like. In example embodiments, a green light indicates that the corresponding bottle 424-1 is the next ingredient to be added to the vessel 452, a yellow light indicates that the bottle 424-1 is one of a plurality of ingredients to be added to the vessel 452 (but not the next ingredient) and a red light or no light indicates that the bottle 424-1 is not one of the ingredients to be added to the vessel 452 or is an ingredient that has already been added to the vessel 452. In example embodiments, the visible indicator 460 is used to indicate when the appropriate amount of an ingredient has been added to the well 490. For example, a green indicator can be used to indicate that an ingredient is the next ingredient to be added to the vessel 452; disabling or flashing the green indicator can be used to indicate that the appropriate amount of an ingredient has been added to the well 490.

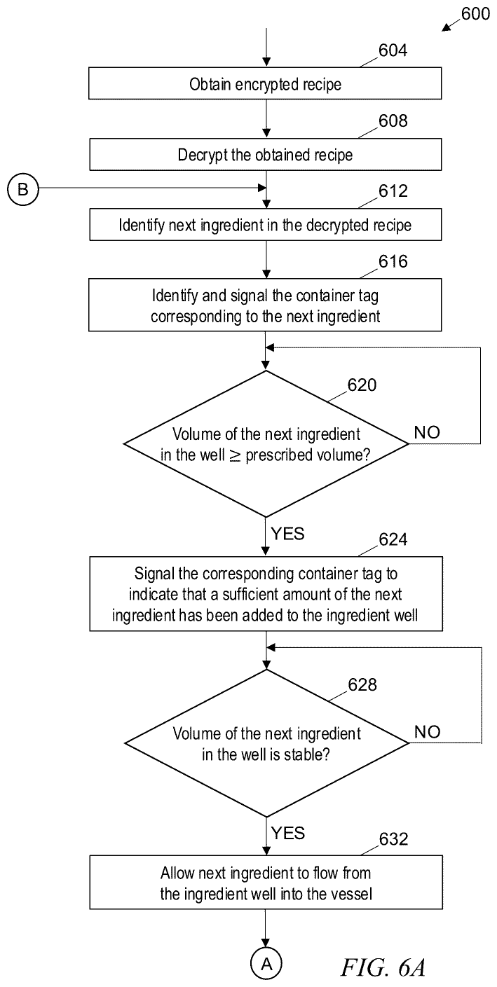

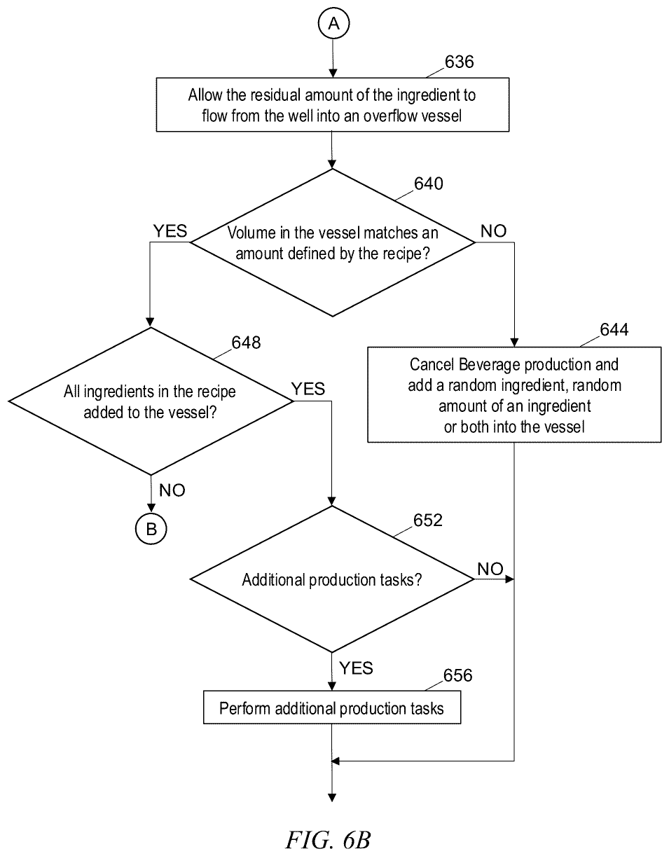

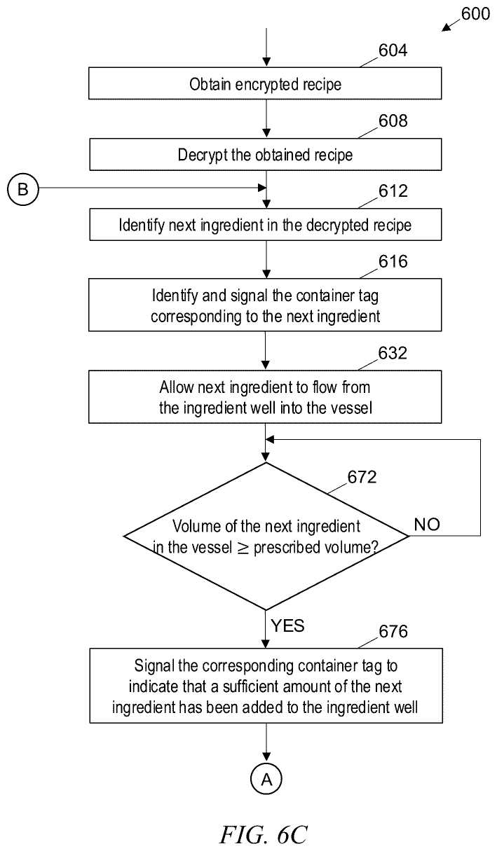

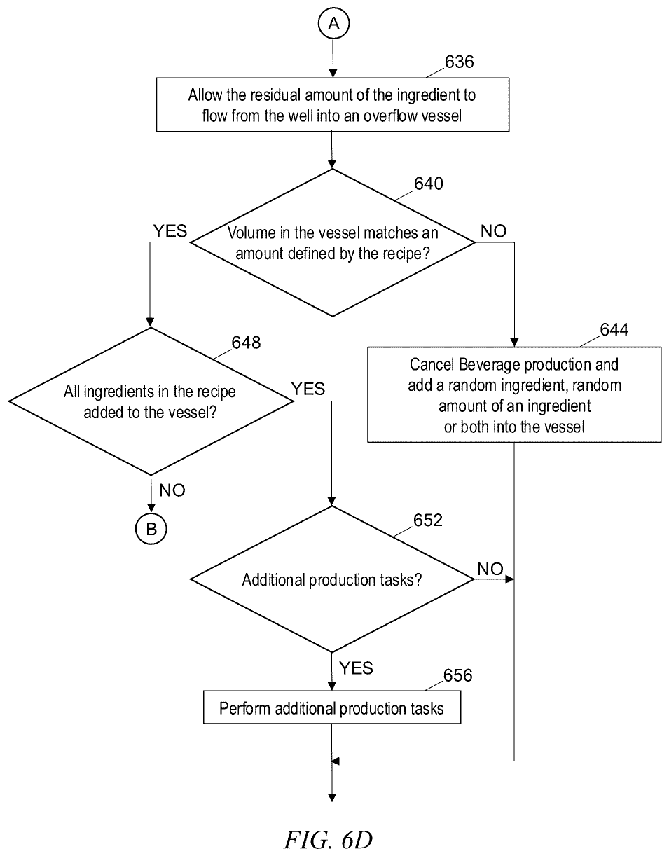

FIGS. 6A-6B illustrate a flowchart for a first example method for producing a beverage or food product, in accordance with example embodiments. In example embodiments, an encrypted recipe 404 is obtained (operation 604). The encrypted recipe 404 is decrypted (operation 608) and the next ingredient (such as the first ingredient) is identified based on the decrypted recipe (operation 612). (In example embodiments, components of the recipe 404 are decrypted individually. For example, the ingredients of the recipe 404, production steps of the recipe 404 and the like may be individually decrypted.) The container tag of the ingredient to be added next to the vessel 452 is identified and the container tag corresponding to the next ingredient is signaled to indicate that the corresponding ingredient is the next ingredient to be used (operation 616). In example embodiments, the container tag map is used to identify the network identifier of the container tag associated with the first ingredient.

A check is then performed to determine if the well level indicator 478-1 indicates that the volume of the ingredient residing in the well 490 is greater than or equal to the volume prescribed by the recipe 404 (operation 620). If the level indicator 478-1 indicates that the volume of the ingredient residing in the well 490 is less than the volume prescribed by the recipe 404 (NO branch of operation 620), the method proceeds with operation 620; otherwise (YES branch of operation 620), the container tag of the current ingredient is signaled to indicate that a sufficient amount of the corresponding ingredient has been added to the well 490 (operation 624).

A check is then performed to determine if the ingredient level indicator 478-1 indicates that the volume of the ingredient residing in the well 490 is stable (indicating that the user has stopped adding ingredients into the well 490) (operation 628). If the level indicator 478-1 indicates that the volume of the ingredient residing in the well 490 is not stable (NO branch of operation 628), the method proceeds with operation 628; otherwise (YES branch of operation 628), the electronically controlled valve 472 allows an amount of the ingredient to flow into the vessel 452, as prescribed by the recipe 404 (operation 632). The amount of an ingredient flowing into the vessel 452 may be measured by the electronically controlled valve 472 as the ingredient flows through the electronically controlled valve 472, by using the level indicator 478-2 (where the amount of the ingredient flowing into the vessel 452 is equal to a present level of the indicator 478-2 minus the total volume residing in the vessel 452 prior to the addition of the ingredient) or both. The electronically controlled valve 472 then allows the residual amount of ingredient in the ingredient well 490 to flow into the overflow vessel 444 (operation 636).

In example embodiments, a check is performed to determine if a volume of the ingredient(s) residing in the vessel 452 matches an expected amount, as prescribed by the recipe 404 (serves to confirm that the food or beverage product is being produced in accordance with the recipe 404 and to confirm that the mixing vessel 452 is properly engaged) (decision block 640). If the volume of the ingredient(s) residing in the vessel 452 does not match the expected amount, as prescribed by the recipe 404 (NO branch of decision block 640), the method cancels the production and requires that the user add a random ingredient, a random amount of an ingredient or both to the vessel 452 (operation 644).

If the volume of the ingredient(s) residing in the vessel 452 matches the expected amount, as prescribed by the recipe 404 (YES branch of decision block 640), a check is performed to determine if all ingredients have been added to the vessel 452, as prescribed by the recipe 404 (decision block 648). If all ingredients have not been added to the vessel 452, as prescribed by the recipe 404 (NO branch of decision block 648), the method proceeds with operation 612 and the next ingredient is identified (operation 612).

If all ingredients have been added to the vessel 452, as prescribed by the recipe 404 (YES branch of decision block 648), a check is performed to determine if the recipe 404 prescribes any additional production tasks, such as stirring, chilling and the like (decision block 652). If the recipe 404 prescribes no additional production tasks (NO branch of decision block 652), the method ends. If the recipe 404 prescribes additional production tasks (YES branch of decision block 652), the production tasks are performed (operation 656) and the method ends.

FIGS. 6C-6D illustrate a flowchart for a second example method for producing a beverage or food product, in accordance with example embodiments. In the method of FIGS. 6C-6D, rather than waiting until a sufficient amount of an ingredient resides in the well 490 before allowing the ingredient to flow into the vessel 452, the ingredient is allowed to flow into the vessel 452 as it is added into the well 490. The amount of ingredient flowing into the vessel 452 may be measured by the electronically controlled valve 472, by using the level indicator 478-2 for the vessel 452 (where the amount of the ingredient flowing into the vessel 452 is equal to a present level of the indicator 478-2 minus the total volume residing in the vessel 452 prior to the addition of the ingredient) or both. (In example embodiments where a weight scale is integrated into the intelligent dispenser 428, the weight of the ingredient instead of or in addition to the volume of the ingredient may be utilized to determine the amount of the ingredient flowing into the vessel 452.) The operations of FIGS. 6C-6D are similar to the operations of FIGS. 6A-6B, except the operations 620-628 are not performed and the following operations are performed between operations 632 and 636, inclusive.

The electronically controlled valve 472 allows an amount of the ingredient to flow into the vessel 452, as prescribed by the recipe 404 (operation 632). A check is then performed to determine if the volume of the ingredient residing in the vessel 452 is greater than or equal to the volume prescribed by the recipe 404 (operation 672). If the volume of the ingredient residing in the well 490 is less than the volume prescribed by the recipe 404 (NO branch of operation 672), the method proceeds with operation 672; otherwise (YES branch of operation 672), the container tag of the current ingredient is signaled to indicate that a sufficient amount of the corresponding ingredient has been added to the well 490 (operation 676). The electronically controlled valve 472 allows the residual amount of the ingredient in the well to flow into the overflow vessel 444 (operation 636). The method then proceeds with operation 640, as described above.

In one aspect, an intelligent dispenser 428 comprises a network interface 432 configured to obtain an encrypted recipe; a well 490 configured to accept an ingredient; and an electronically controlled valve 472 having a valve input and a first valve output, and configured to control a flow of an ingredient from the well 490 to the first valve output based on the encrypted recipe.

In example embodiments, a vessel 452 is configured to capture the flow of the ingredient from the first valve output.

In example embodiments, the vessel 452 is further configured to engage with a vessel mating mechanism.

In example embodiments, a locking mechanism is configured to prevent a disengagement of the vessel 452 from the vessel mating mechanism prior to a completion of a production of a beverage.

In example embodiments, an engagement mechanism 494 is configured to enable the processor to confirm that the vessel 452 is properly attached to a vessel mating mechanism while a beverage is being produced.

In example embodiments, a processor is configured to orchestrate a decryption of the encrypted recipe.

In example embodiments, the electronically controlled valve 472 further comprises a second valve output and the intelligent dispenser 428 further comprises an overflow vessel 444 configured to capture a residual amount of the ingredient from the well 490 and the electronically controlled valve 472 is further configured to control a flow of the residual amount of the ingredient from the well 490 to the overflow vessel 444 via the second valve output.

In example embodiments, the processor is further configured to identify a next ingredient to add to the vessel 452 via the electronically controlled valve 472.

In example embodiments, the electronically controlled valve 472 further comprises a processor configured to decrypt the encrypted recipe.

In example embodiments, the processor is further configured to identify an ingredient of the recipe 404 on a display screen 496.

In example embodiments, the network interface and the processor are further configured to identify each ingredient of the recipe 404 by turning on a remotely located indicator 460.

In example embodiments, the processor is further configured to determine at least one of a random amount and a random ingredient, and to transmit a signal identifying the determined at least one of the random amount and the random ingredient.

In example embodiments, a receptacle 482 is configured to mate with an ingredient container.

In example embodiments, a receptacle 482 is configured to mate with a cap 484 of an ingredient container.

In example embodiments, a temperature sensor 488 is configured to monitor a temperature of a beverage in the vessel 452 and the processor is further configured to monitor the temperature of the beverage in the vessel 452 and indicate when the temperature of the beverage in the vessel 452 conforms to a given temperature specified by the recipe 404.

In example embodiments, a temperature sensor is configured to monitor a temperature of contents of the vessel and a chiller is configured to chill contents of the vessel, wherein the processor is further configured to control the chiller based on the monitored temperature and the recipe.

In example embodiments, a mixer 486 is configured to mix or stir contents of the vessel 452 in accordance with the recipe 404.

In example embodiments, a quick response (QR) code reader 480 is configured to read a quick response (QR) code that identifies the recipe 404.

In example embodiments, a temperature sensor 488 is configured to monitor a temperature of contents of the vessel 452 and a chiller 492 is configured to chill the contents of the vessel 452, wherein the processor 440 is further configured to control the chiller 492 based on the monitored temperature and the recipe 404.

In example embodiments, an electric mixer 486 is configured to mix contents of the vessel 452, wherein the processor 440 is further configured to control the electric mixer 486 based on the recipe 404.

In example embodiments, a well level indicator 478-1 is configured to indicate a height (volume) of the ingredient residing in the well 490.

In example embodiments, a vessel level indicator 478-2 is configured to indicate a height (volume) of the ingredient residing in the vessel 452.

In one aspect, a container tag 528 comprises a network interface 504; a processor 508 configured to indicate a status of a corresponding ingredient received via the network interface based on a decrypted recipe; a display driver 516; and a display 460 configured to display the status of the corresponding ingredient via the display driver 516.

In example embodiments, a first mating mechanism of the container tag 528 is configured to mate with a receptacle 482 of an intelligent dispenser 428; and a second mating mechanism is configured to mate with a container.

In example embodiments, the container tag 528 includes a code reader.

Although certain examples are shown and described here, other variations exist and are within the scope of the invention. It will be appreciated by those of ordinary skill in the art that any arrangement, which is designed or arranged to achieve the same purpose, may be substituted for the specific embodiments shown. This application is intended to cover any adaptations or variations of the example embodiments of the invention described herein. It is intended that this invention be limited only by the claims, and the full scope of equivalents thereof.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network 115 (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

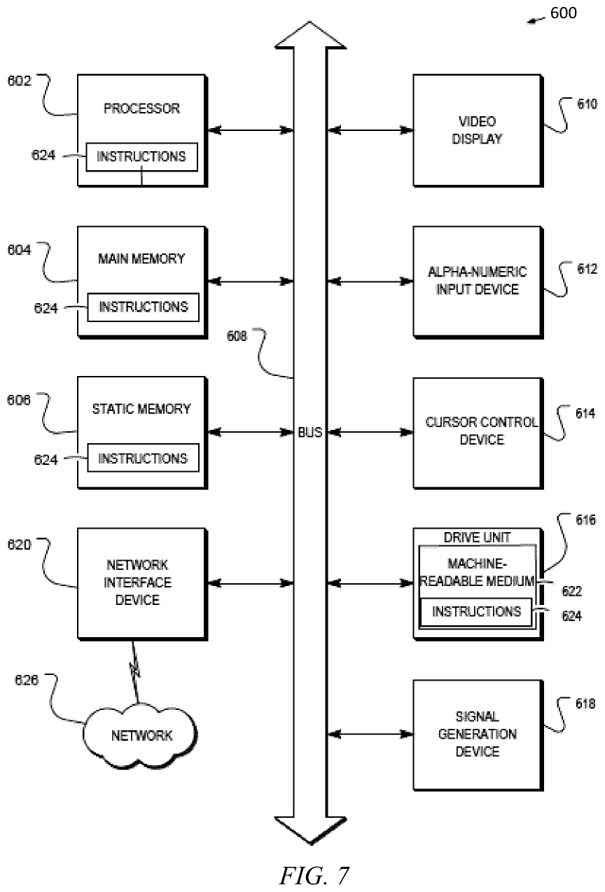

FIG. 7 is a block diagram of a machine within which instructions may be executed for causing the machine to perform any one or more of the methodologies discussed herein. In one example embodiment, an instance of the machine of FIG. 7 may be a component of the mixing machine 104, the user device 112, and/or the beverage processing server 108. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a user interface (UI) navigation device 614 (e.g., a mouse), a disk drive unit 616, a signal generation device 618 (e.g., a speaker) and a network interface device 620.

### Machine-Readable Medium

The drive unit 616 includes a machine-readable medium 622 on which is stored one or more sets of instructions 624 and data structures (e.g., software) embodying or utilized by any one or more of the methodologies or functions described herein. The instructions 624 may also reside, completely or at least partially, within the main memory 604 and/or within the processor 602 during execution thereof by the computer system 600, the main memory 604 and the processor 602 also constituting machine-readable media. Instructions 624 may also reside within the static memory 606.

While the machine-readable medium 622 is shown in an example embodiment to be a single medium, the term “machine-readable medium” may include a single medium or multiple media (e.g., a centralized or distributed database, and/or associated caches and servers) that store the one or more instructions 624 or data structures. The term “machine-readable medium” shall also be taken to include any tangible medium that is capable of storing, encoding or carrying instructions 624 for execution by the machine and that cause the machine to perform any one or more of the methodologies of the present invention, or that is capable of storing, encoding or carrying data structures utilized by or associated with such instructions 624. The term “machine-readable medium” shall accordingly be taken to include, but not be limited to, solid-state memories, and optical and magnetic media. Specific examples of machine-readable media 622 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 624 may further be transmitted or received over a communications network 626 using a transmission medium. The instructions 624 may be transmitted using the network interface device 620 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., WIFI and WiMax networks). The term “transmission medium” shall be taken to include any intangible medium that is capable of storing, encoding or carrying instructions 624 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An intelligent dispenser comprising:
a network interface configured to obtain an encrypted recipe;
a well configured to accept an ingredient; and
an electronically controlled valve having a valve input and a first valve output, and configured to control a flow of the ingredient from the well to the first valve output based on the encrypted recipe.

2. The intelligent dispenser of claim 1, further comprising a vessel configured to capture the flow of the ingredient from the first valve output.

3. The intelligent dispenser of claim 2, further comprising a vessel mating mechanism and wherein the vessel is further configured to engage with the vessel mating mechanism.

4. The intelligent dispenser of claim 3, further comprising a locking mechanism configured to prevent a disengagement of the vessel from the vessel mating mechanism prior to a completion of a production of a beverage.

5. The intelligent dispenser of claim 1, wherein the electronically controlled valve further comprises a second valve output and wherein the intelligent dispenser further comprises an overflow vessel configured to capture a residual amount of the ingredient from the well and wherein the electronically controlled valve is further configured to control a flow of the residual amount of the ingredient from the well to the overflow vessel via the second valve output.

6. The intelligent dispenser of claim 1, wherein the electronically controlled valve further comprises a processor configured to orchestrate a decryption of the encrypted recipe.

7. The intelligent dispenser of claim 6, further comprising a vessel mating mechanism and an engagement mechanism configured to enable the processor to confirm that a vessel is properly attached to the vessel mating mechanism while a beverage is being produced.

8. The intelligent dispenser of claim 6, wherein the processor is further configured to identify a next ingredient to add to the vessel via the electronically controlled valve.

9. The intelligent dispenser of claim 6, further comprising a display screen and wherein the processor is further configured to identify an ingredient of the recipe on the display screen.

10. The intelligent dispenser of claim 6, wherein the network interface and the processor are further configured to identify each ingredient of the recipe by turning on a remotely located indicator.

11. The intelligent dispenser of claim 6, wherein the processor is further configured to determine at least one of a random amount and a random ingredient, and to transmit a signal identifying the determined at least one of the random amount and the random ingredient.

12. The intelligent dispenser of claim 6, further comprising a temperature sensor configured to monitor a temperature of a beverage in the vessel and wherein the processor is further configured to monitor the temperature of the beverage in the vessel and indicate when the temperature of the beverage in the vessel conforms to a given temperature specified by the recipe.

13. The intelligent dispenser of claim 6, further comprising a temperature sensor configured to monitor a temperature of contents of the vessel and a chiller configured to chill the contents of the vessel, wherein the processor is further configured to control the chiller based on the monitored temperature and the recipe.

14. The intelligent dispenser of claim 6, further comprising an electric mixer configured to mix contents of the vessel, wherein the processor is further configured to control the electric mixer based on the recipe.

15. The intelligent dispenser of claim 1, further comprising a receptacle configured to mate with an ingredient container.

16. The intelligent dispenser of claim 1, further comprising a receptacle configured to mate with a cap of an ingredient container.

17. The intelligent dispenser of claim 1, further comprising a chiller configured to chill a beverage to a temperature as defined by the recipe.

18. The intelligent dispenser of claim 1, further comprising a mixer configured to mix or stir a beverage in a vessel in accordance with the recipe.

19. The intelligent dispenser of claim 1, further comprising a quick response (QR) code reader configured to read a quick response (QR) code that identifies the recipe.

20. The intelligent dispenser of claim 1, further comprising a well level indicator, the well level indicator configured to indicate a height or volume of the ingredient residing in the well.

21. The intelligent dispenser of claim 1, further comprising a vessel level indicator, the vessel level indicator configured to indicate a height or volume of the ingredient residing in the vessel.

22. A container tag comprising:
a network interface;
a processor configured to indicate a status of a corresponding ingredient received via the network interface based on a decrypted recipe;
a display driver; and
a display configured to display the status of the corresponding ingredient via the display driver 516.

23. The container tag of claim 22, further comprising:
a first mating mechanism configured to mate with a receptacle of an intelligent dispenser; and
a second mating mechanism configured to mate with a container.

24. The container tag of claim 22, further comprising a code reader.
